(19) United States
(12) Patent Application Publication
(10) Pub. No.: US 2017/0146828 A1
(43) Pub. Date: May 25, 2017

(54) METHOD OF COLOR-DYEING A LENS FOR GOGGLES AND GLASSES

(71) Applicants: Carl Zeiss Vision Italia S. p. A., Varese (IT); Carl Zeiss Vision International GmbH, Aalen (DE)

(72) Inventors: Roberto Padovani, Malnate (DE); Davide Terzi, Milano (IT); Thomas Gloege, Aalen (DE); Eberhard Uhl, Aalen (DE)

(21) Appl. No.: 15/403,017

(22) Filed: Jan. 10, 2017

Related U.S. Application Data
(63) Continuation of application No. PCT/EP2015/065655, filed on Jul. 9, 2015.

(30) Foreign Application Priority Data
Jul. 10, 2014 (EP) 14176428.2

(51) Int. Cl. G02C 7/10; D06P 3/52; D06P 1/92; B05D 1/18; D06P 1/00

(52) U.S. Cl. CPC G02C 7/108; B05D 1/18; D06P 1/0016; D06P 1/928; D06P 3/52

(57) ABSTRACT

A method of color-dyeing a lens for goggles and glasses, whereby the lens includes a polycarbonate substrate, the method including the steps of: providing a liquid mixture of components including at least one dye or pigment, suitable for color-dyeing polycarbonate and a dispersion medium, whereby the at least one dye or pigment is dispersed as colloids in the dispersion medium; immersing the substrate into the mixture such that the at least one dye or pigment is impregnated into the substrate; and withdrawing the substrate from the mixture. The method is characterized in that the dispersion medium includes a solvent for dissolving the at least one dye or pigment, whereby the solvent includes at least one member selected from the group including an organic alcohol, in particular an aromatic alcohol, in particular benzylic alcohol; a butyl acetate, and a methacrylate ester, in particular methyl methacrylate.

### CROSS REFERENCE TO RELATED APPLICATIONS

This application is a continuation application of international patent application PCT/EP2015/065655, filed Jul. 9, 2015, designating the United States and claiming priority from European application 14176428.2, filed Jul. 10, 2014, and the entire content of both applications is incorporated herein by reference.

### FIELD OF THE INVENTION

The present invention relates to a method of color-dyeing a lens for goggles and glasses, in particular a method for color dyeing polycarbonate.

### BACKGROUND OF THE INVENTION

Color-tinted lenses have been developed for goggles and glasses to reduce light transmission and to mitigate glare. There are lenses with a graded tint which are especially useful for sports which require a clear view of proximal terrain and objects yet a reduced glare when viewing distant terrain or objects.

Polycarbonate is a useful lens material for sports goggles and glasses because it is strong, durable and lightweight. However, polycarbonate lenses have always presented a challenge for those who wish to tint them.

Polycarbonate may be compounded with a dye, for example a fabric dye, so as to exhibit a uniform color tint when formed into a lens. In particular, the polycarbonate may be compounded with the dye and forming pellets. A method for producing such pellets is, for example, disclosed in United States patent application publication 2011/0128494 A1. The colored polycarbonate pellets were used for extruding or injection molding of a lens. In particular, polycarbonate lenses without optical power can be produced easily by injection molding of colored polycarbonate pellets. These processes are limited to the generation of unicolored lenses. Gradient tints, bicolored lenses or tint-on demand to personally chosen colors is impossible.

With lenses made from CR-39° monomer the tinting process is very straightforward. The textile dyes, which are mostly based on azo-chemistry, in the tinting bath can diffuse relatively easily into the substrate matrix leading to fast tinting processes and dark lenses. Polycarbonate, unfortunately, is very resistant to this type of tints.

Therefore, currently most polycarbonate lenses are tinted in the hard coating. The better the hard coating the harder it is to tint. The first type of coatings that were applied to polycarbonate were so resistant to tints that obtaining a sunglass shade was almost, if not, impossible (see BPI internet page: http://www.callbpi.com/supporVpoly.html). In recent years, the types of coatings that are used on polycarbonate lenses have changed considerably. It is much more common today to see a combination of coatings used on polycarbonate. Typically the front surface, which tends to receive the most scratches during processing, is coated already in the mass manufacturing site. The back surface is commonly coated with a tintable coating, that is, UVNV®, by the optical lab after surfacing. This coating on the back surface is definitely tintable, even to relatively dark sunglass shades. Three different process ways are possible with these lenses:

1. they are sold as hard-coat-only products directly;

2. they are over-coated with another (non-tintable) hard-coat by dip-coating processes to yield more scratch resistant coatings on top which is processed further or sold that way; or,

3. it can be coated directly with a suitable anti-reflective coating.

The compatibility of different coatings one upon the other and to the polycarbonate surface is an ongoing issue which can lead to delamination in worst case scenarios. Different concepts to overcome this issue were therefore investigated.

United States patent application publication 2013/0329184 A1 describes ophthalmic lens products comprising a multilayer wafer and an injection-molded polycarbonate inner portion. The multilayer wafer includes a dyed, photochromic or polarized layer between a tinted inner layer and an outer polymeric layer. The inner layer may be solid or gradient-tinted. The polycarbonate inner portion of the lens product is directly fused to the tinted inner layer of the multilayer wafer during injection molding. This document further describes a method to produce a gradient-tinted polarized polycarbonate eyewear lens product by obtaining a multilayer wafer having an outer layer, an inner polycarbonate layer, and a polarized layer between the inner and outer layers, applying a gradient tint to the wafer's inner layer, placing the gradient tinted wafer within an injection-molding cavity, and injecting molten polycarbonate directly against the wafer's gradient-tinted layer to form the inner portion of the lens product and to fuse it to the wafer.

United States patent application publication 2009/0015786 A1 discloses a general concept of tinting of inter alia polycarbonate corrective lenses. The transparent base material of the corrective lens is tinted to the desired color for correction by immersion in a colorant dye. If desired, the dyes may be heated during immersion.

EP 0 687 765 A2 relates to a method for color-dyeing polycarbonate, and particularly, for color-dyeing a polycarbonate sheet by immersion in a moderated solvent dye mixture. The method is especially useful in the manufacture of tinted lenses. It is disclosed that polycarbonate may be color-tinted by immersion into a mixture of a dye or pigment in a solvent blend. Alternatively, the polycarbonate may be coated with a coloring dye and solvent blend and thereafter dried in an oven. The solvent blend attacks the polycarbonate and enables the dye or pigment to be impregnated within the polycarbonate material.

Also, it is preferable in some cases to heat the mixture to improve impregnation. The temperature of the mixture should be maintained below the glass transition temperature of polycarbonate (approximately 150° C.) and preferably below 120° C.

According to an embodiment disclosed in EP 0 687 765 A2, the solvent blend comprises an impregnating solvent and a moderating solvent. The impregnating solvent attacks the polycarbonate and enables impregnation of the dye or pigment. The moderating solvent acts as a diluent and wetting agent and reduces the aggressiveness of the impregnating solvent.

The impregnating solvent may include at least one solvent selected from dipropylene glycol monomethyl ether (DPM) and tripropylene glycol monomethyl ether (TPM), and propylene glycol monomethyl ether (PM). The impregnating solvents are aggressive polycarbonate solvents. Used at full strength, these impregnating solvents attack polycarbonate materials and easily form microcracks therein, which tend to propagate and cause greater cracking.

To prevent the impregnating solvent from attacking the polycarbonate sheet too aggressively, a moderating solvent is blended with the impregnating solvent. Exemplary moderating solvents include propylene glycol (PG), 1,4 butane diol, and ethylene glycol monobutyl ether (EB).

In order to impart a graded tint, the polycarbonate material which is immersed in a solvent mixture may be slowly withdrawn from the mixture. The graded tint results because the partition of the material which remains in the mixture longest is impregnated with the most dye.

According to an alternative method disclosed in EP 0687 765 A2, also, a polycarbonate material, can be flow-coated with a mixture described in the foregoing. The flow-coated material is then dried in an oven for a length of time sufficient to evaporate the mixture and dry the material.

Despite the tinting method using a solvent blend as described in EP 0 687 765 A2 has been proved and tested there is still a further need for quality improvement.

United States Patent application publication 2002/0040511 A1 discloses a method for tinting of polycarbonate optical lenses of the kind the invention bases on by immersing the polycarbonate optical lenses in an aqueous dispersion of tinting agent and exposing the dispersion and immersed polycarbonate optical lenses to microwave radiation to bring the dispersion to ebullition; the ebullition is maintained for at least 2 seconds with transfer of tinting agent from the dispersion to the article to tint the article; the tinted article is removed from the dispersion and rinsed with water.

The immersion of microwave radiation has drawbacks in some kind of mass manufacturing processes. In particular the fabrication of lenses with a graded tint provides difficulties.

### SUMMARY OF THE INVENTION

It is therefore an object of the present invention to provide a method of forming a tinted polycarbonate lens for glasses or goggles, and especially such a lens with a graded tint. Such a lens may, in addition, be coated with a highly mar-resistant chemically inert clear coating.

The object can, for example, be achieved via a method of color-dyeing a lens for goggles and glasses, whereby the lens includes a polycarbonate substrate, the method including the following steps:
providing a liquid mixture of components including at least one dye or pigment, suitable for color-dyeing polycarbonate and a dispersion medium, whereby the at least one dye or pigment is dispersed as colloids in the dispersion medium;
immersing the polycarbonate substrate into the mixture such that the at least one dye or pigment is impregnated into the polycarbonate substrate; and,
withdrawing the polycarbonate substrate from the mixture.

The method is characterized in that the dispersion medium includes a solvent for dissolving the at least one dye or pigment. The solvent includes at least one member selected from the group consisting of an aromatic alcohol which solubilizes the dye or pigment, an amido-functionalized aromatic compound, a butyl acetate, and a methacrylate ester, in particular methyl methacrylate. The aromatic alcohol, may be, for example benzylic alcohol. The amido-functionalized aromatic compound in general has a molar mass between 100 and 1000 g/mol. Such an amido-functionalized aromatic compound is, for example, commercially available under the trademark Zetadif®. The compounds mentioned above serve as solvents for the dyes as well as the dispersing medium in water. Furthermore, these compounds attack the polycarbonate substrate, that is, the polycarbonate material which is the carrier of the optical power of the lens due to its surface contour as well as the carrier of any coating which may be applied thereon.

The molar ratio between the dye or pigment and the (organic) solvent preferably is between 0.05 mol % and 5.00 mol %, preferably between 0.06 mol % and 2.00 mol %, more preferably between 0.07 mol % and 1.00 mol % and most preferably between 0.10 mol % and 0.50 mol %.

In particular, when using benzylic alcohol as a solvent the molar ratio between the dye or pigment and the benzylic alcohol preferably is between 0.05 mol % and 5.00 mol %, preferably between 0.06 mol % and 2.00 mol %, more preferably between 0.07 mol % and 1.00 mol % and most preferably between 0.10 mol % and 0.50 mol %. This means that in general solutions with approximately 5 to 10 grams of the dyestuff in 1 liter benzylic alcohol are appropriate.

For Zetadif® as a solvent approximately the same molar ratios between the dye or pigment and the amido-functionalized aromatic compound are preferred. This means that in general solutions with approximately 20 to 80 grams of the dyestuff in 1 liter Zetadif® are appropriate.

Therefore, the liquid mixture may include approximately 0.1 to 10 vol %, preferably 0.5 to 5 vol %, more preferably 0.7 to 2.5 vol % and most preferably 1.0 to 1.5 vol % colorant solutions (dyestuff and solvent, for example, dyestuff and benzylic alcohol) in total. For example when using three different dyestuffs the first one may include 0.3 vol %, the second one 0.5 vol % and the third one 0.7 vol % giving in total 1.5 vol % colorant solution in the liquid mixture.

In particular, when using benzylic alcohol as a solvent, the liquid mixture may include approximately 0.1 to 10 vol %, preferably 0.5 to 5 vol %, more preferably 0.7 to 2.5 vol % and most preferably 1.0 to 1.5 vol % colorant solutions (that is, dyestuff and benzylic alcohol) in total.

In particular when using Zetadif® as a solvent, the liquid mixture may include approximately 0.05 to 5.00 vol %, preferably 0.10 to 2.50 vol %, more preferably 0.15 to 2.00 vol % and most preferably 0.20 to 1.50 vol % colorant solutions (that is, dyestuff and Zetadif®) in total.

The independency of the new process on injection molding of tinted polycarbonate pellets opens the potential product portfolio. Not only unicolored, but bicolored and gradient tints on all types of polycarbonate lenses, namely single vision lenses (SV), progressive addition lenses (PAL), bifocal, trifocal, polarized, full product portfolio are possible. The process according to the invention doesn't require the application of tintable hard-coatings anymore as compared to that disclosed, for example, in United States patent application publication 2006/0148952 A1. The reduced number of coating layers decreases the investment into coating machinery. The durability of lenses is improved due to the reduction of interfaces. This influences the adhesion of the overall coating stack positively.

The process is not only applicable to plano or non-prescription sun glasses but may in particular be applied to tinting of prescription (Rx) lenses having optical power. In particular single vision lenses and progressive addition lenses may be tinted with the method according to the invention.

The liquid mixture may further include a surfactant or a mixture of different surfactants that lower the surface tension or interfacial tension between the liquid mixture and the polycarbonate substrate and enables impregnation of the at least one dye or pigment into the polycarbonate substrate. Additionally the surfactants work as detergents cleaning the lens surface during the process. Additionally the surfactants together with the organic solvent works as dispersant for the dye stuff in aqueous solution.

The surfactant may include at least one member selected from the group consisting of linear alkylbenzenesulfonates, lignin sulfonates, fatty alcohol ethoxylates, and alkylphenol ethoxylates. Particular examples are 4-(5-dodecyl) benzenesulfonate, sodium stearate, sodium lauryl sulfate or sodium lauryl ether sulfate, dioctyl sodium sulfosuccinate, perfluorooctanesulfonate (PFOS), perfluorobutanesulfonate, linear alkylbenzene sulfonates (LABs), polyoxyethylene glycol alkyl ethers or polyoxypropylene glycol alkyl ethers like polyethylene glycol ether, propylene glycol monomethyl ether, dipropylene glycol monomethyl ether (DPM), and tripropylene glycol monomethyl ether. Some of these compounds are disclosed in EP 0 687 765 A2 mentioned above.

The liquid mixture may include approximately 0.5 to 15 volt, preferably 1 to 10 vol %, more preferably 2 to 8 vol % and most preferably 3 to 7 vol % surfactant in total. For example when using Zetapon®, that is, DPM, as a surfactant good results are achieved when using 5 to 6 vol %.

The liquid mixture may further include a moderating agent that acts as a diluent and wetting agent and reduces the aggressiveness of the surfactant. It might serve if appropriate to control pH of the mixture. An appropriate moderating agent may include at least one member selected from the group consisting of propylene glycol, 1,4 butane diol, ethylene glycol monobutyl ether, lithium hydroxide, sodium hydroxide, and potassium hydroxide.

The liquid mixture may include approximately 0.001 to 0.1 vol %, preferably 0.002 to 0.05 vol %, more preferably 0.005 to 0.025 vol % and most preferably 0.01 to 0.02 vol % surfactant in total. For example when OP141, for example, potassium hydroxide, as a moderating agent good results are achieved when using a volume ratio of 10 ml/100 l. This means that approximately 10 ml of OP141 per 100 l of the liquid mixture are sufficient to stabilize the pH around 7.

Preferably, the pH of the liquid mixture is between 5 and 9, more preferably between 6 and 8, and most preferably between 6.5 and 7.5.

In order to enhance process control the dispersion medium and/or the liquid mixture may further include a certain amount of water, in particular deionized water. Water may act as control agent for the chemical interaction between the above solvents of the dye as well as may act as adjustment agent of the dye concentration.

The amount of deionized water in the liquid mixture is preferably between 80 vol % and 99.5 vol %, preferably between 85 vol % and 99 vol %, most preferably between 90 vol % and 99 vol %.

In general, the liquid mixture of components including at least one dye or pigment, suitable for color-dyeing polycarbonate and a dispersion medium, whereby the at least one dye or pigment is dispersed as colloids in the dispersion medium is prepared, in particular mixed at room temperature or a temperature between 10° C. to 75° C., most likely between 15° C. and 45° C. This temperature in general is not sufficient to tint polycarbonate lenses with sufficient velocity. While EP 0 687 765 A2 recommends heating of the mixture with the dye or pigment to temperatures close to the glass transition temperature of polycarbonate, the inventors found out that using the mixture according to the invention requires to keep the mixture below the boiling temperature of water in order to have the composition of the mixture as constant as possible and to prevent from decomposition of the mixture as such or any of the components.

The method according to the invention therefore may further include a step of heating the mixture to a heating temperature to form a heated mixture before the immersing step, whereby the heating temperature at atmospheric pressure is between 80° C. and the boiling temperature of water, preferably between 90° C. and the boiling temperature of water and more preferable between 90° C. and 96° C. Tinting velocity increases significantly at temperatures above 80° C.

Preferably, the heating step lasts during the immersing step. It is also possible that the heating step starts after the immersing step. It is also possible that the heating step stops prior to the end of the immersing step. It is also possible to vary the temperature with time during the immersion step.

It has been found that the resulting dispersion provided by the liquid mixture is unstable and regular treatment for stabilization is required, which can, that is, be provided by a magnetic stirrer, heat, an ultrasonic bath or a combination thereof. Therefore preferably, besides the heating step the method further includes a step of mechanical stirring the mixture to form a homogenized mixture before the immersing step. The mechanical stirring, for example, via the magnetic stirrer or the ultrasonic source, may be conducted during the immersing step.

Both heating and mechanical stirring may occur independently and/or (in part) simultaneously.

Summarizing the foregoing, polycarbonate lenses preferably are tinted by dipping them into the respective dye dispersion at increased temperature which is between 80 and 100° C., ideally 90° C. and 96° C., for a prolonged period of time depending on the degree of absorption which is desired. During tinting the dispersion must be agitated strongly to stabilize the colloids and to reduce chances for generation of uneven tints in the lens.

Subsequently, that is, after the tinting process as such, namely after withdrawing the polycarbonate substrate from the mixture and after, for example, further optional drying and/or after, for example, any form changing working step the usual treatment can be continued, in particular a step of depositing at least one functional layer onto the polycarbonate substrate may follow. The at least one functional layer may include at least one member selected from the group consisting of a hard coating, an antireflective coating, a reflecting coating, a polarizing coating, an antifogging coating, a clean coating and an antistatic coating.

In order to clarify, the polycarbonate substrate prior to the above tinting process may already include one or more functional layers such as a hard coating, in the following called factory hard coating. The factory hard coating of polycarbonate lenses may be chosen in a way to provide the required protection for the in general convex front lens surface during Rx treatment of the concave back surface without interference in the tinting process. The factory coating might be stripped before tinting or stabilized in a way to survive the increased temperature in water without decay. If the factory hard coating prevents tinting of the front side then the tinting time must be adjusted to allow even deep tints via the diffusion of dyes into the back side only.

According to the invention the at least one dye or pigment may include at least one member selected from the group consisting of the (poly)methane colorants, the azo colorants, the coumarin colorants, the perinone colorants, the perilene colorants, the amino ketone colorants, the anthraquinone colorants, the quinophthalone colorants, and the pyrazolone colorants. These suitable dyes or colorants can be found in the LANxess Macrolex®, the Clariant PV Fast, Graphtol, DrizPearls, Solvaperm, Polysynthren, Hostasol, Hostaprint, Hostasin, Hostacryl and the BASF Heliogen®, Lithol®, Paliogen®, Paliotol®, Sicomin®, Sicopal®, Sicotan®, Sicotrans®, Lumogen® class of products. The dyes are available through the whole visible spectrum spanning from red to violet (see, for example, brochure “LANxess Energizing Chemistry Macrolex Bayplast Colorants for Plastics”, Edition: 2007-10, Order No.: LXS-FCC23E, published by LANXESS Deutschland GmbH, Business Unit Functional Chemicals, Chemiepark Leverkusen, 51369 Leverkusen, Germany; brochure “The Coloration of Plastics and Rubber”, Edition: January 2007, Order No.: DP 8528 E_01/07, published by Clariant Produkte (Deutschland) GmbH, ‘Pigments & Additives Division, Marketing Plastic Business, 65926 Frankfurt a. M., Germany and brochure “Colorants for plastics colorations—organic and inorganic pigments, soluble dyestuffs”, Edition: December 2005, Order No.: EVP 008905 e, published by BASF Aktiengesellschaft, Performance Chemicals for Coatings, Plastics and Specialties, 67056 Ludwigshafen, Germany). The suitable combination of a limited number of dyes allows the generation of all desired colors. It has to be taken into account during the generation of dye bath recipes that the dyes exhibit different diffusion speeds into the polycarbonate matrix. The wide variety of different available dyes provides the opportunity to produce lenses sporting all desired colors. The new tinting process of polycarbonate substrate material is based on the application of dyes which were up to now only used during extrusion or injection molding of unpolar, thermoplastic lens materials. The unsuitable conventional (textile) dyes are fully substituted by dyes which can diffuse into polycarbonate. The new dyes are insoluble in water due to their unpolar character. They must be dispersed as colloids by application of carefully chosen surfactants in combination with benzylic alcohol or other suitable chemical compounds (that is, Zetadif®, which is an amido-functionalized aromatic compound).

In a further preferred embodiment the providing a liquid mixture of components step may include a step of providing each of the at least one dye or pigment being separately dispersed as colloids in the dispersion medium up to their saturation limit.

Advantageously this further preferred embodiment may include that the providing a liquid mixture of components step further includes a step of mixing at least two of the provided dyes or pigments being separately dispersed as colloids in the dispersion medium up to their saturation limit.

In particular the providing a liquid mixture of components step further may include a step of mixing at least two of the provided dyes or pigments being separately dissolved in a solvent including at least one member selected from the group consisting of an aromatic alcohol, in particular benzylic alcohol; a butyl acetate, and a methacrylate ester, in particular methyl methacrylate preferably up to their solubility limit.

In order to impart a graded tint, the polycarbonate substrate may be slowly immersed into the liquid mixture. Alternatively and or in addition the immersed polycarbonate substrate may be slowly withdrawn from the mixture. The graded tint results because the partition of the material which remains in the mixture longest is impregnated with the most dye. In other words the immersing step may be performed gradually and/or the withdrawing step may be performed gradually. The velocity of immersion or the velocity of withdrawal in order to get graded tinted polycarbonate substrates preferably is between 0.5 cm/s and 2 cm/s.

### BRIEF DESCRIPTION OF THE DRAWING

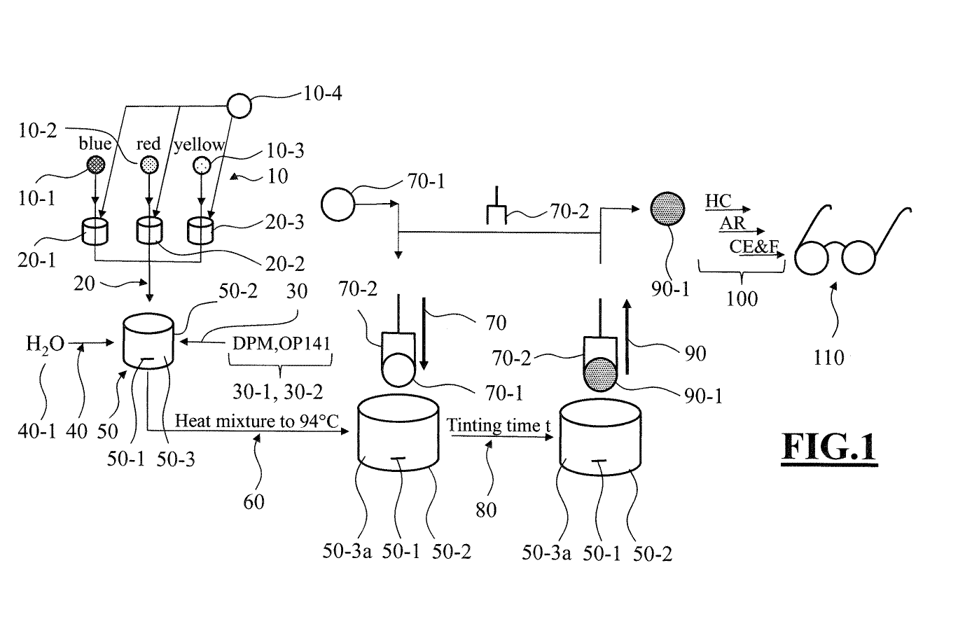

The invention will now be described with reference to the single FIGURE of the drawing (FIG. 1) which shows a simplified example of a process according to the invention to obtain tinted polycarbonate lenses.

### DESCRIPTION OF THE PREFERRED EMBODIMENTS OF THE INVENTION

FIG. 1 shows a graphical representation of a simplified example of method according to the invention to obtain tinted polycarbonate lenses. In a first step 10 the dyes 10-1, 10-2, 10-3 are each separately dissolved in benzylic alcohol 10-4 up to their solubility limit. In the example three dyes 10-1, 10-2, 10-3, for example, blue, red and yellow, are dissolved in benzylic alcohol 10-4 forming dye solutions 20-1, 20-2, 20-3. The dye solutions 20-1, 20-2, 20-3 in benzylic alcohol 10-4 are mixed in a second step 20 in the required amounts c (see Table 1) and in a further step 30 supplemented with surfactants 30-1, 30-2, first dipropylene glycol monomethyl ether (DPM) then aqueous solution of potassium hydroxide (for example, Deconex OP141) to obtain a brown solution.

TABLE 1
Recipe for Brown Tint

| | MACROLEX | New Red | MACROLEX | | |
|---|---|---|---|---|---|
| | Yellow 6R | TBLS | Blue 3R | DPM | OP141 |
| concentration c | Methine- | dyestuff | Anthraquinone | dipropylen | aqueous |
| | dyestuff | mixture | dyestuff | glycol mono | solution of |
| | | | | methylether | potassium |
| | | | | | hydroxide |
| ml/1 | 1.7 | 11.0 | 3.7 | 4.8 | 0.2 |

The missing volume share is filled in step 40 by deionized water 40-1. The mixing steps 20, 30, 40 are performed at room temperature under vigorous stirring 50. The stirring step 50 is conducted via a magnetic stirrer 50-1. The tinting bath is indicated in the drawing via the reference numeral 50-2, the mixture via reference numeral 50-3.

In step 60 the mixture is stirred and heated to 94° C., which yields a homogeneous dispersion 50-3a. Then a polycarbonate lens 70-1, hereinafter referred to as polycarbonate substrate in order to distinguish from a coated lens, in appropriate lens holder 70-2 is fully submerged in the homogenized mixture 50-3a in step 70. The time in the tinting bath 50-3 according to step 80 has to be adjusted according to desired degree of absorption. In step 90 the tinted polycarbonate lens 90-1 is withdrawn from the tinting bath 50-3a via the lens holder 70-2. Table 2 summarizes the results for different time schedules t and their respective luminous transmission T in the visible spectral range, measured under an incidence angle α of 2° and standard illumination D65.

TABLE 2
Optical Analysis of Polycarbonate Lenses

| | | | | |
|---|---|---|---|---|
| Tinting time t | 30 | 60 | 120 | 300 |
| (min) | | | | |
| Luminous | 42 | 35 | 24 | 16 |
| Transmission T | | | | |
| (%), D65, 2° | | | | |

Subsequently the usual Rx treatment 100 can be continued, in particular hard and anti-reflective coating HC, AR, followed by Cut, Edge and Fit processes C, E & F resulting in a pair of glasses or spectacles 110, respectively.

The recipe shown in Table 1 leads to a brown lens color.

It is understood that the foregoing description is that of the preferred embodiments of the invention and that various changes and modifications may be made thereto without departing from the spirit and scope of the invention as defined in the appended claims.

What is claimed is:

1. A method of color-dyeing a lens for goggles or glasses, wherein the goggles or glasses comprise a lens comprising a polycarbonate substrate, the method comprising the steps of:
providing a liquid mixture comprising at least one dye or pigment, and a dispersion medium, wherein said at least one dye or pigment is dispersed as colloids in said dispersion medium;
immersing said polycarbonate substrate into said liquid mixture such that said at least one dye or pigment is impregnated into said polycarbonate substrate; and
withdrawing said polycarbonate substrate from said liquid mixture;
wherein said dispersion medium comprises a solvent comprising at least one aromatic alcohol, amido-functionalized aromatic compound, butyl acetate, and/or methacrylate ester.

2. The method according to claim 1, wherein the mol ratio between said at least one dye or pigment and said solvent is between 0.05 mol % and 5.00 mol %, 0.06 mol % and 2.00 mol %, 0.07 mol % and 1.00 mol %, or 0.10 mol % and 0.50 mol %.

3. The method according to claim 1, wherein said liquid mixture further comprises a surfactant in a sufficient amount to lower the surface tension or interfacial tension between said liquid mixture and said polycarbonate substrate, and in a sufficient amount to impregnate said polycarbonate substrate with said at least one dye or pigment.

4. The method according to claim 3, wherein said surfactant comprises at least one of linear alkylbenzenesulfonates, lignin sulfonates, fatty alcohol ethoxylates, and alkylphenol ethoxylates, sodium stearate, sodium lauryl sulfate, sodium lauryl ether sulfate, dioctyl sodium sulfosuccinate, perfluorooctanesulfonate (PFOS), perfluorobutanesulfonate, linear alkylbenzene sulfonates (LABs), polyoxyethylene glycol alkyl ethers, polyoxypropylene glycol alkyl ethers.

5. The method according to claim 1, wherein said liquid mixture further comprises a moderating agent.

6. The method according to claim 5, wherein said moderating agent comprises at least one of propylene glycol, 1,4 butane diol, ethylene glycol monobutyl ether, lithium hydroxide, sodium hydroxide, and potassium hydroxide.

7. The method according to claim 1, wherein said dispersion medium and/or said liquid mixture further comprises water.

8. The method according to claim 1, further comprising: heating said liquid mixture thereby forming a heated mixture, before said immersing step and/or during said immersing step, wherein said heating temperature is between 80° C. and the boiling temperature of water, between 90° C. and the boiling temperature of water, or between 90° C. and 96° C.

9. The method according to claim 1, further comprising depositing at least one functional layer onto said polycarbonate substrate.

10. The method according to claim 9, wherein said at least one functional layer comprises at least one of a hard coating (HC), an antireflective coating (AR), a reflecting coating, a polarizing coating, an antifogging coating, a clean coating, and an antistatic coating.

11. The method according to claim 1, wherein said at least one dye or pigment comprises at least one (poly)methane colorants, azo colorants, coumarin colorants, perinone colorants, perilene colorants, amino ketone colorants, anthraquinone colorants, quinophthalone colorants, and pyrazolone colorants.

12. The method according to claim 1, wherein said providing a liquid mixture of components step further comprises providing each of said at least one dye or pigment separately dispersed as colloids in said dispersion medium in an amount not exceeding their saturation limit.

13. The method according to claim 1, wherein said providing a liquid mixture of components step further comprises mixing at least two of said at least one dye or pigment separately dispersed as colloids in said dispersion medium in an amount not exceeding their saturation limit.

14. The method according to claim 12, wherein said providing a liquid mixture of components step further comprises mixing at least two of said at least one dye or pigment separately dissolved in a solvent comprising at least one alcohol, a butyl acetate, and a methacrylate ester.

15. The method according to claim 1, wherein in said immersing step and/or said withdrawing step said polycarbonate substrate is immersed into said liquid mixture with a velocity of 0.5 cm/s to 2 cm/s and/or said polycarbonate substrate is withdrawn from said liquid mixture with a velocity of 0.5 cm/s to 2 cm/s.

16. The method according to claim 1, wherein said solvent comprises at least one of benzyl alcohol and methyl methacrylate.

17. The method according to claim 4, wherein the surfactant comprises at least one of polyethylene glycol ether, propylene glycol monomethyl ether, dipropylene glycol monomethyl ether, and tripropylene glycol monomethyl ether.

18. The method according to claim 14, wherein said solvent comprises at least one of benzyl alcohol and methyl methacrylate.
